(19) United States
(12) Patent Application Publication
(10) Pub. No.: US 2026/0350853 A1
(43) Pub. Date: Nov. 5, 2026

(54) IMAGE GENERATION MODEL FOR TRANSPARENT BACKGROUNDS

(71) Applicant: ADOBE INC., SAN JOSE, CA (US)

(72) Inventors: Yijun Li, Seattle, WA (US); Qing Liu, Santa Clara, CA (US); He Zhang, Santa Clara, CA (US); Zhifei Zhang, San Jose, CA (US); Jianming Zhang, Cupertino, CA (US); Zhe Lin, Cupertino, CA (US)

(21) Appl. No.: 19/195,923

(22) Filed: May 1, 2025

(51) Int. Cl. G06T 11/00; G06T 7/194

(52) U.S. Cl. CPC G06T 11/00; G06T 7/194; G06T 2211/441

(57) ABSTRACT

A method, apparatus, non-transitory computer readable medium, and system for generating a synthetic image includes obtaining an input prompt indicating an object. An image generation model is configured to generate a latent embedding based on the input prompt, wherein the latent embedding includes a latent color channel corresponding to at least a part of the object and a latent alpha channel. Subsequently, the image generation model generates the synthetic image based on the latent embedding, wherein the synthetic image depicts the object based on the latent color channel and includes an alpha channel based on the latent alpha channel.

### BACKGROUND

The following generally relates to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for image processing, more specifically to image generation. Embodiments of the present disclosure include an image processing apparatus configured to obtain an input text including an element and generate an output image. In some cases, the image generation model is configured to generate the image with an associated alpha channel from the input text. For example, the image processing apparatus is configured to generate a layered synthetic image comprising different values of transparency for a foreground and a background region of the image.

A method, apparatus, and non-transitory computer readable medium for image processing are described. One or more aspects of the method, apparatus, and non-transitory computer readable medium include obtaining an input prompt indicating an object; generating, using an image generation model, a latent embedding based on the input prompt, wherein the latent embedding includes a latent alpha channel and a latent color channel corresponding to at least a part of the object; and generating, using the image generation model, a synthetic image based on the latent embedding, wherein the synthetic image depicts the object based on the latent color channel and includes an alpha channel based on the latent alpha channel.

A method, apparatus, and non-transitory computer readable medium for image processing are described. One or more aspects of the method, apparatus, and non-transitory computer readable medium include obtaining an input prompt including a depiction of an object on a background; generating, using an image generation model, a latent embedding based on the input prompt, wherein the latent embedding represents the object and transparency information corresponding to the background of the object; and generating, using the image generation model, a synthetic image based on the latent embedding, wherein the synthetic image depicts the object and includes an alpha channel in place of the background.

An apparatus and system for image processing are described. One or more aspects of the apparatus and system include a memory component; a processing device coupled to the memory component, the processing device configured to perform operations comprising: obtaining an input prompt indicating an object; generating, using an image generation model, a latent embedding based on the input prompt, wherein the latent embedding includes a latent color channel corresponding to at least a part of the object and a latent alpha channel; and generating, using the image generation model, a synthetic image based on the latent embedding, wherein the synthetic image depicts the object based on the latent color channel and includes an alpha channel based on the latent alpha channel.

### BRIEF DESCRIPTION OF THE DRAWINGS

FIG. 1 shows an example of an image processing system according to aspects of the present disclosure.

FIG. 2 shows an example of a method for generating a composite image according to aspects of the present disclosure.

FIG. 3 shows an example of a composite image generation process according to aspects of the present disclosure.

FIG. 4 shows an example of an image segmentation process according to aspects of the present disclosure.

FIG. 5 shows an example of a composite image generation process according to aspects of the present disclosure.

FIG. 6 shows an example of a latent diffusion process according to aspects of the present disclosure.

FIG. 7 shows an example of an image generation framework according to aspects of the present disclosure.

FIG. 8 shows an example of an image generation framework including stroke information according to aspects of the present disclosure.

FIG. 9 shows an example of an image segmentation framework according to aspects of the present disclosure.

FIG. 10 shows an example of a diffusion transformer (DiT) architecture 1000 according to aspects of the present disclosure.

FIG. 11 shows an example of a U-Net architecture according to aspects of the present disclosure.

FIG. 12 shows an example of a denoising diffusion process according to aspects of the present disclosure.

FIG. 13 shows an example of a method for image processing according to aspects of the present disclosure.

FIG. 14 shows an example of a criteria for data filtering according to aspects of the present disclosure.

FIG. 15 shows an example of a method of training an ML model according to aspects of the present disclosure.

FIG. 16 shows an example of a method of training a diffusion model according to aspects of the present disclosure.

FIG. 17 shows an example of a computing device according to aspects of the present disclosure.

FIG. 18 shows an example of an image processing apparatus according to aspects of the present disclosure.

FIG. 19 shows an example of an image generation model according to aspects of the present disclosure.

### DETAILED DESCRIPTION

The present disclosure describes systems and methods for image processing, more specifically to image generation. Embodiments of the present disclosure include an image processing apparatus configured to obtain an input text including an element and generate an output image depicting the element. In some cases, the image generation model is configured to generate the image with an associated alpha channel from the input text. For example, the image processing apparatus is configured to generate a layered synthetic image comprising different values of transparency for a foreground and a background region of the image.

Existing text-to-image generation models (e.g., Dalle-E, Imagen, Stable Diffusion, etc.) are only able to generate a single RGB image result. In some cases, such models are unable to generate images that are visually appealing. For example, such models are unable to generate complex objects with detailed boundaries that require omission of unnecessary pixels. Particularly, for example, when extracting complex objects such as “a woman with flowing hair”, such models include additional unnecessary pixels along the hair which results in low visual appeal of the generated image.

In some cases, existing image generation systems generate an image with a combined foreground and background, i.e., the foreground region and the background region in the image are not separated. In some cases, an additional neural network is used for such separation which results in increased use of computational resources. In some cases, existing systems are unable to accurately segment the foreground and the background regions since the data distribution from the image generation and image segmentation is different.

Additionally, existing text-to-image generation models are inaccurate when the generated image includes transparent objects or backgrounds. Some existing image generation systems generate alpha channels along with the RGB image. In some cases, such systems are unable to perform the generation as a single-step process, i.e., perform generation of a pre-multiplied RGB image as a first step followed by obtaining the alpha channel as a second step. That is, such image generation systems do not model the RGBA data distribution as a one-step process and hence cannot be extended to a different application (e.g., other downstream applications).

By contrast, embodiments of the present disclosure are configured to perform the image generation as a single-step process. In some cases, the image generation model of the present disclosure is configured to generate a synthetic image and perform separation of a background region and a foreground region of the image in a single network. Additionally, the image generation model is able to incorporate an input conditioning (such as a user-stroke and an image and a rough mask). Accordingly, by incorporating the additional input conditions, embodiments of the present disclosure are able to provide increased flexibility and are able to be extended for a plurality of real-world applications.

The present disclosure describes systems and methods for image generation. Embodiments of the present disclosure include an image generation model configured to generate an image with an alpha channel. In some cases, the alpha channel is obtained from a text prompt. For example, the image generation model generates an image (e.g., a layered PNG file) with different values of transparency for each of the foreground and the background regions. In some examples, the image is incorporated into a different background (e.g., the image is placed on a different canvas) which eases the designing process.

Embodiments of the present disclosure include an image generation model configured to generate an image depicting a transparent background. In some cases, the image generation model comprises a diffusion model with RGB channels (i.e., color channels) representing an image and an A channel representing the alpha channel. According to an embodiment, the image generation model comprises a modified diffusion network that learns to directly model RGBA data distribution.

Embodiments of the present disclosure include an image generation model configured to jointly learn a 4-channel RGBA distribution. In some cases, the image generation model extends a latent space of an RGB model from a 12-channel to a 16-channel. For example, the image generation model comprises a dual-encoder single-decoder architecture to perform the extension to the 16-channel.

An embodiment of the present disclosure includes an image generation model configured to incorporate a user input. In some cases, the image generation model includes increased controllability by incorporating user stroke as a condition. For example, the user-stroke is a coarse mask drawn by a user that indicates an approximate shape of an asset (i.e., a user-desired asset). In some examples, the image generation model generates an RGBA asset that accurately matches the approximate shape of the user-stroke.

An embodiment of the present disclosure includes an image generation model configured to incorporate an additional user input. In some cases, the image generation model incorporates an image as a conditioning, wherein the image generation model extracts an RGBA version of the foreground in the image. In some examples, the extracted RGBA foreground depicts an increased color-decontaminated boundary. In some examples, the extracted RGBA foreground is used for image composition.

As described herein, an input prompt refers to input text that indicates an object. For example, the input prompt is “a glass cup on a checkerboard background” which includes a transparent object (i.e., glass cup). Additionally, for example, the input prompt is “a woman with flying hair in dreadlocks style” which includes a detailed object (i.e., flying hair in dreadlocks style). In some cases, the latent embedding refers to a representation of an object (e.g., the object in the input prompt) or image in a lower-dimensional space that includes a color channel and an alpha channel.

In some cases, the color channel refers to a component of the image that represents intensity values for a specific color. A digital image is represented in the RGB color model, which has three primary channels: red (R), green (G), and blue (B) that define the color information for each pixel in the image. Here, the alpha channel in an image represents the level of transparency for each pixel that exists with the Red, Green, and Blue (RGB) channels in an image. The alpha channel values range from 0 to 255 (if using 8-bit data), where 0 indicates complete transparency, 255 indicates complete opacity, and values between 0 and 255 indicate partial transparency.

In some cases, the RGB channel and the alpha channel are input layers during preprocessing. In some cases, a pixel value across the channels is normalized and input to an image encoder of the image generation model. In some cases, based on the processing via the image encoder, the channel data is used to generate the latent embedding that includes the relationship between colors, textures, spatial, and transparency information.

Accordingly, embodiments of the disclosure improve on conventional image generation models by generating more accurate outputs including transparency. For example, by implementing the dual-encoder single-decoder architecture for simultaneous learning of the 4-channel RGBA distribution, embodiments of the present disclosure are able to ensure consistency and correspondence between the RGB channel and the alpha channel which results in accuracy in image generation including complex objects (e.g., complex objects, fluffy objects, transparent objects with non-transparent backgrounds, etc.). Additionally, use of the single image generation model of the present disclosure results in preventing use of additional model overhead while minimizing the likelihood of prediction errors.

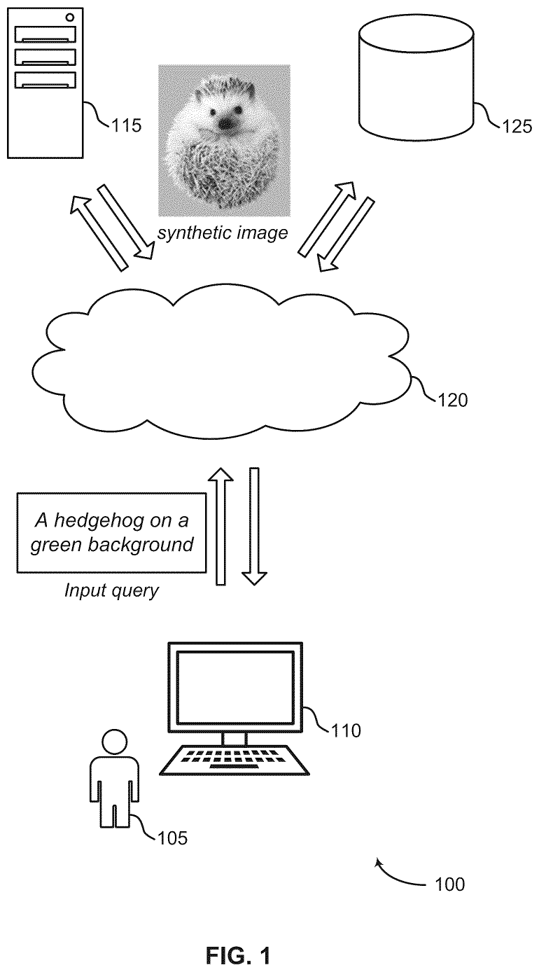

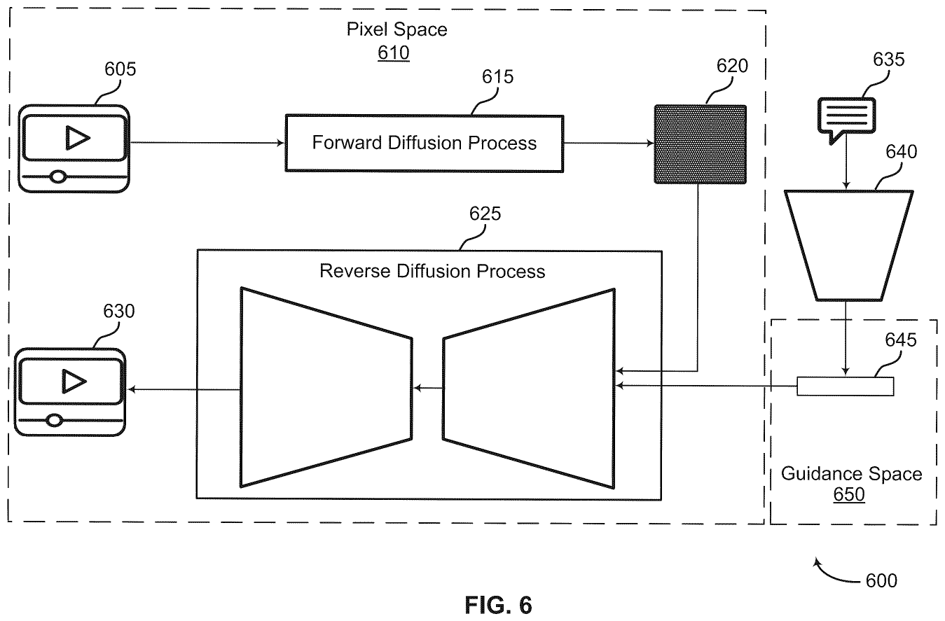

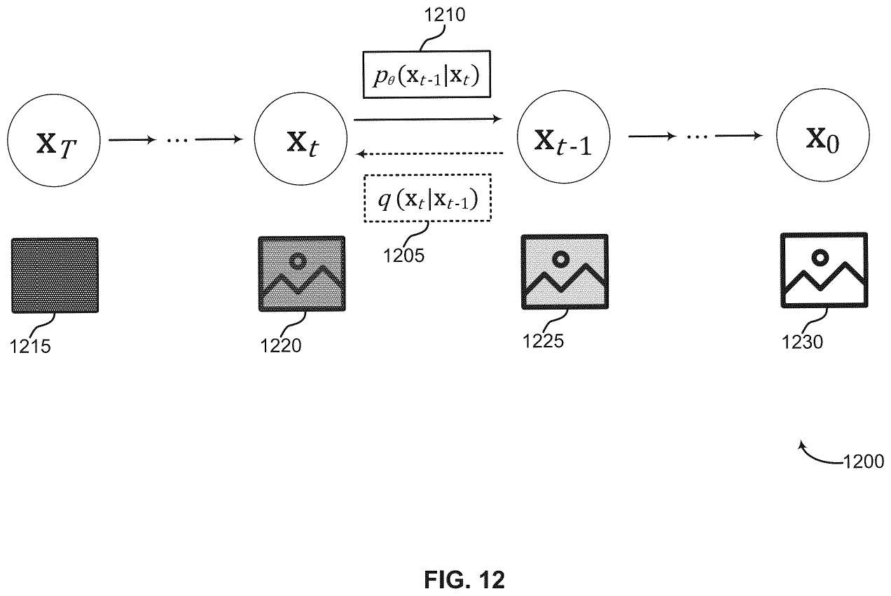

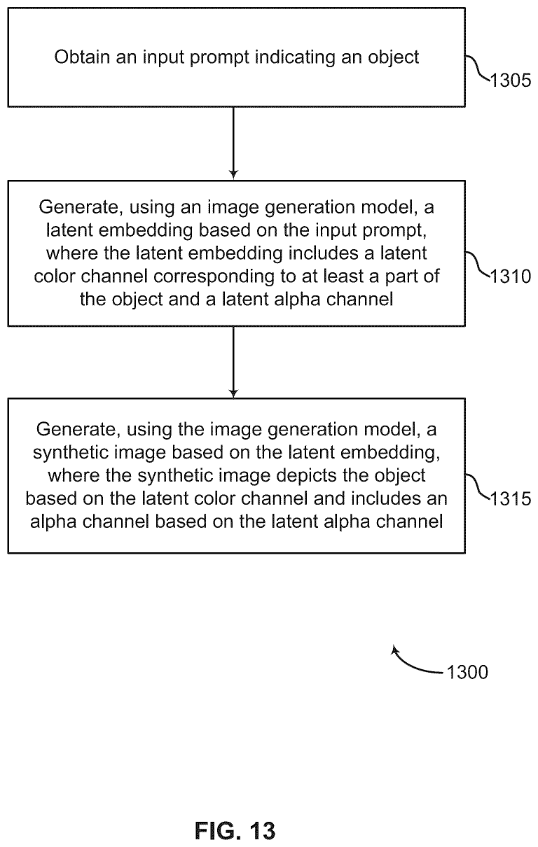

Embodiments of the present disclosure can be implemented in an image processing system. For example, the image processing system based on the present disclosure takes an input prompt (e.g., describing a target element) and generates an output image that accurately depicts the element described in the prompt. Example applications regarding generating an image that depicts an element are provided with reference to FIGS. 1-5. Details regarding the architecture of the image generation model are provided with reference to FIGS. 6-11 and 16-18. Details regarding an operation of the image generation model are provided with reference to FIG. 12. Examples of a process for training the image generation model are provided with reference to FIGS. 13-15.

### Image Processing System

A system and an apparatus for image processing are described with reference to FIGS. 1-11. FIG. 1 shows an example of an image processing system 100 according to aspects of the present disclosure. In one aspect, image processing system 100 includes user 105, user device 110, image processing apparatus 115, cloud 120, and database 125.

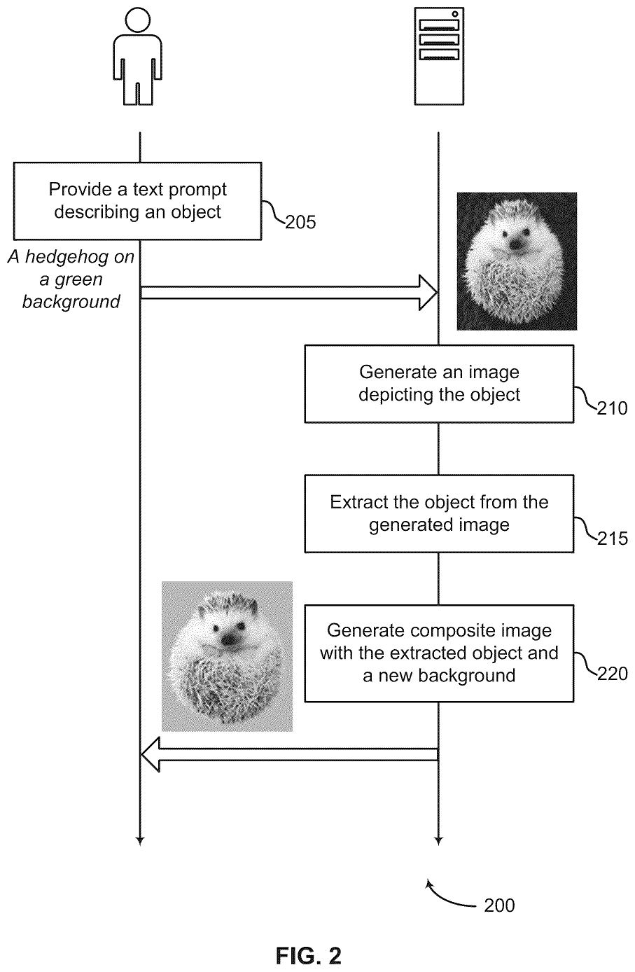

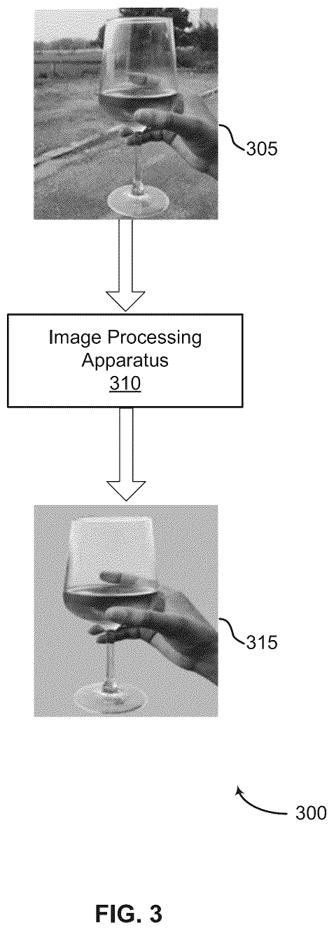

In the example of FIG. 1, user provides a query with an element (e.g., a hedgehog) to image processing apparatus 115 via a user interface provided on user device 110 by image processing apparatus 115. In some examples, the input query is an input text (such as shown in FIGS. 1-2). In some examples, the input query is an input image (such as shown in FIGS. 3-5). As shown in FIG. 1, the input prompt is a text that provides details on an element and a background (e.g., “a hedgehog on a green background”) based on which the user wants to generate a synthetic image using the image processing apparatus 115 of the present disclosure.

In some cases, the image processing apparatus 115 implements an image generation model (such as the image generation model described with reference to at least FIGS. 6-11) to generate a synthetic image that is based on the input prompt. In some cases, as shown in FIG. 1, the user provides an input query (e.g., a text prompt) to the image processing apparatus 115, aspects of which the user wants to depict in the synthetic image. In some examples, the image processing apparatus generates a synthetic image that accurately aligns with the information provided by the input query.

In some cases, the user provides an input query (e.g., an image as shown in FIGS. 3-5) to the image processing apparatus 115, which the user wants to modify in the synthetic image. In some examples, the image processing apparatus generates the synthetic image (e.g., composite image) that accurately modifies the elements provided in the input image. Image processing apparatus 115 is an example of, or includes aspects of, the corresponding element described with reference to FIGS. 3-5.

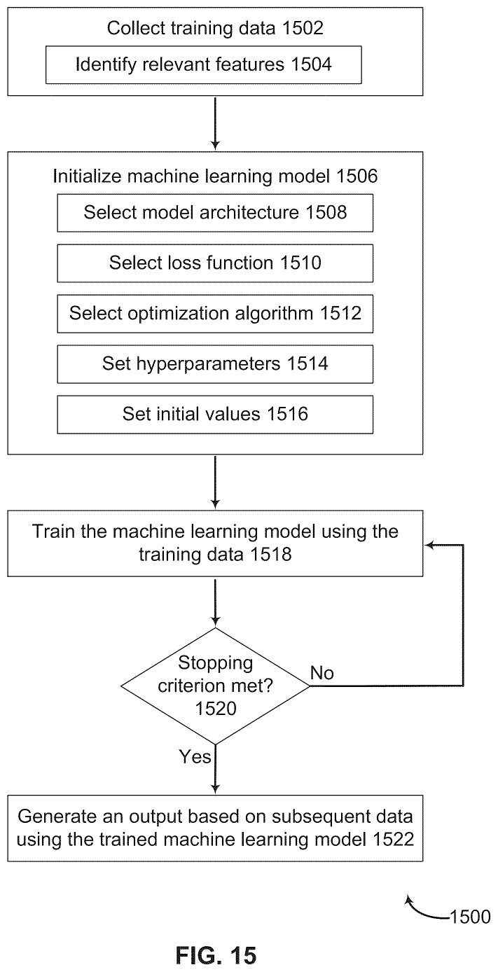

Referring again to the example of FIG. 1, the image processing apparatus 115 generates the synthetic image that accurately depicts (or modifies) an aspect (e.g., element) described by the input query. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, a canvas, etc.) to be communicated between user 105 and image processing apparatus 115. Image processing apparatus 115 is an example of, or includes aspects of, the corresponding element described with reference to FIG. 15.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

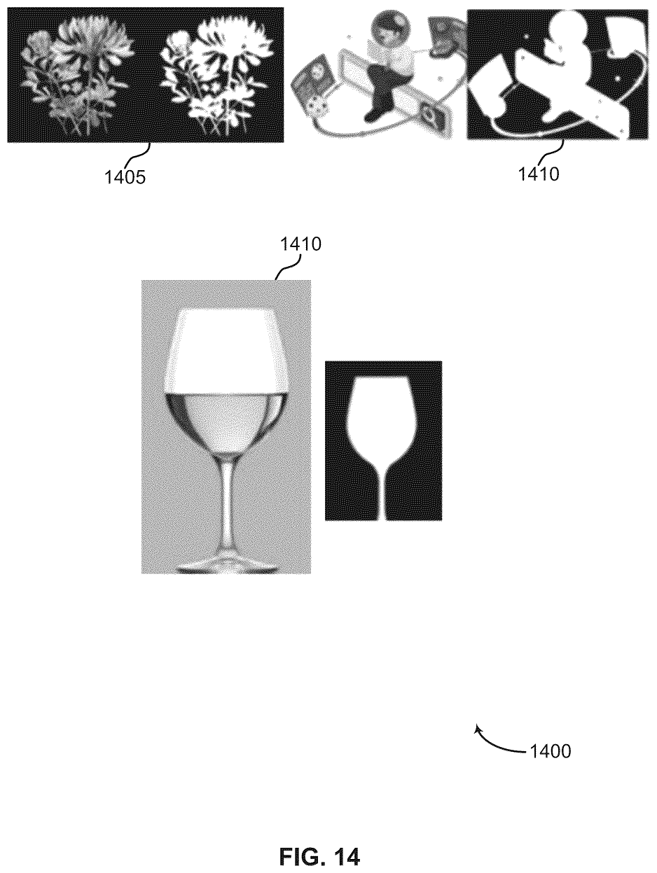

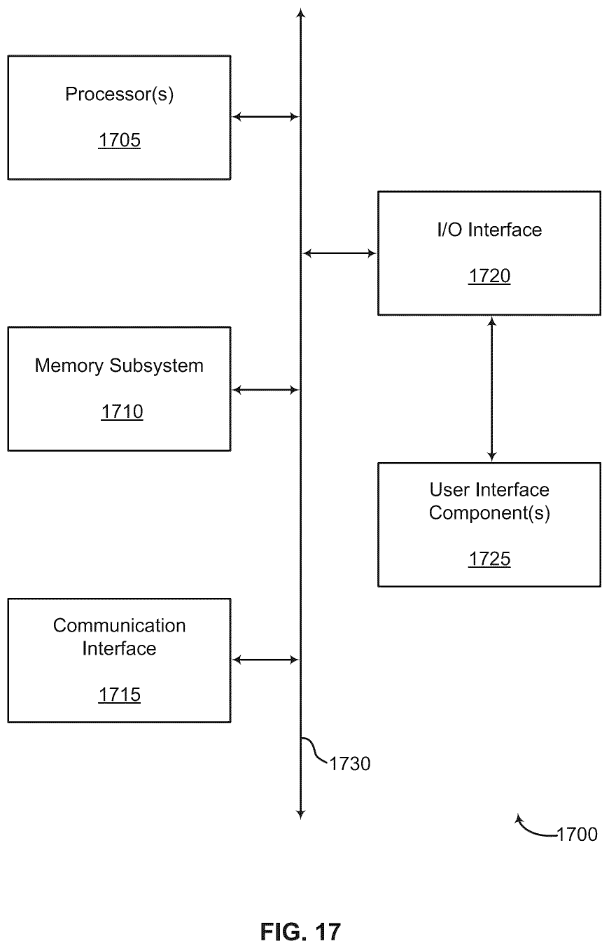

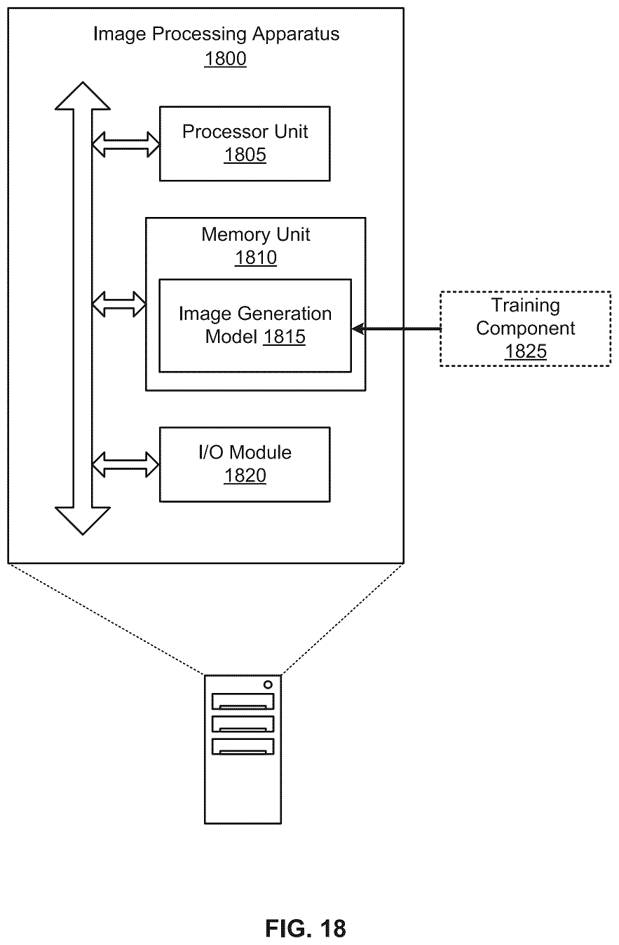

According to some aspects, image processing apparatus 115 includes a computer-implemented network. In some embodiments, the computer-implemented network includes an image generation model (such as the image generation model described with reference to at least FIGS. 17-18). In some embodiments, image processing apparatus 115 also includes one or more processors, a memory subsystem, a communication interface, an I/O interface, one or more user interface components, and a bus as described with reference to FIG. 14. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

FIG. 2 shows an example of a method 200 for generating a composite image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, an image processing apparatus (such as the image processing apparatus described with reference to FIGS. 3 and 17) provides an image generation model (such as the image generation model described with reference to FIGS. 17-18) that accurately generates a synthetic image depicting the element described in the input query.

At operation 205, the system provides a text prompt describing an object. In some cases, the operations of this step refer to, or may be performed by, a user as described with reference to FIG. 1. In some cases, the text prompt provides an object based on which the user wants to generate an image. For example, the user provides a text prompt instructing the image processing apparatus to generate an image that accurately aligns with the text prompt.

At operation 210, the system generates an image depicting the object. In some cases, the operations of this step refer to, or may be performed by, an image processing apparatus as described with reference to FIG. 17.

In some cases, the image processing apparatus includes an image generation model comprising a diffusion model (such as the diffusion model described with reference to at least FIGS. 6-11) that is configured to generate an image with a corresponding alpha channel. In some cases, the image generation model generates the image comprising the object based on the text prompt. In some examples, the generated image depicts a background color that is different from the user-provided text prompt. In some cases, the generated image includes different values of transparency values for a foreground region and a background region of the image.

At operation 215, the system extracts the object from the generated image. In some cases, the operations of this step refer to, or may be performed by, an image processing apparatus as described with reference to FIG. 17.

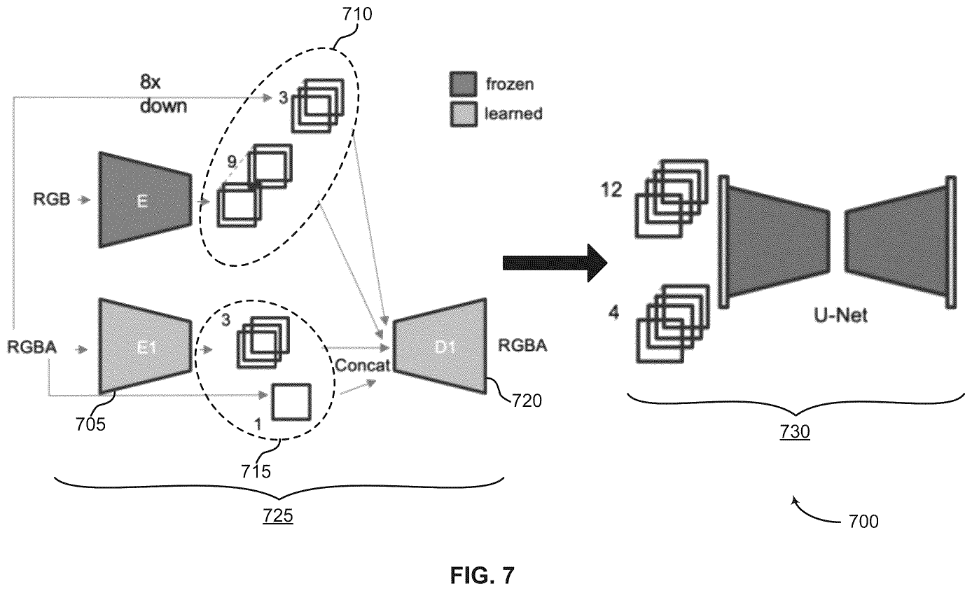

According to an exemplary embodiment, the image generation model comprises a modified diffusion network (such as described with reference to FIGS. 7-9) that is configured to generate an image with a transparent background. In some examples, the modified diffusion network is configured to learn to model a data distribution associated with the image and the alpha channel.

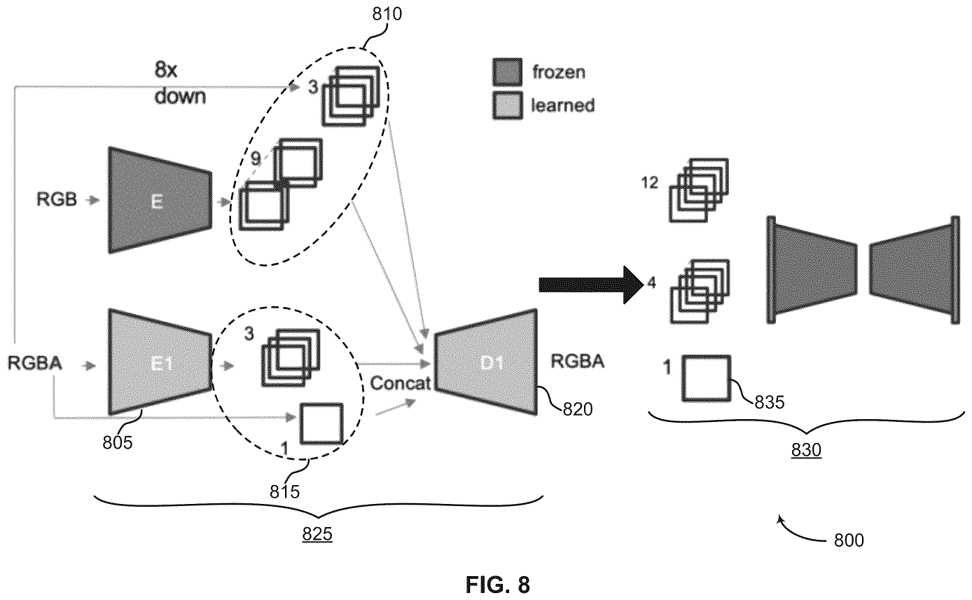

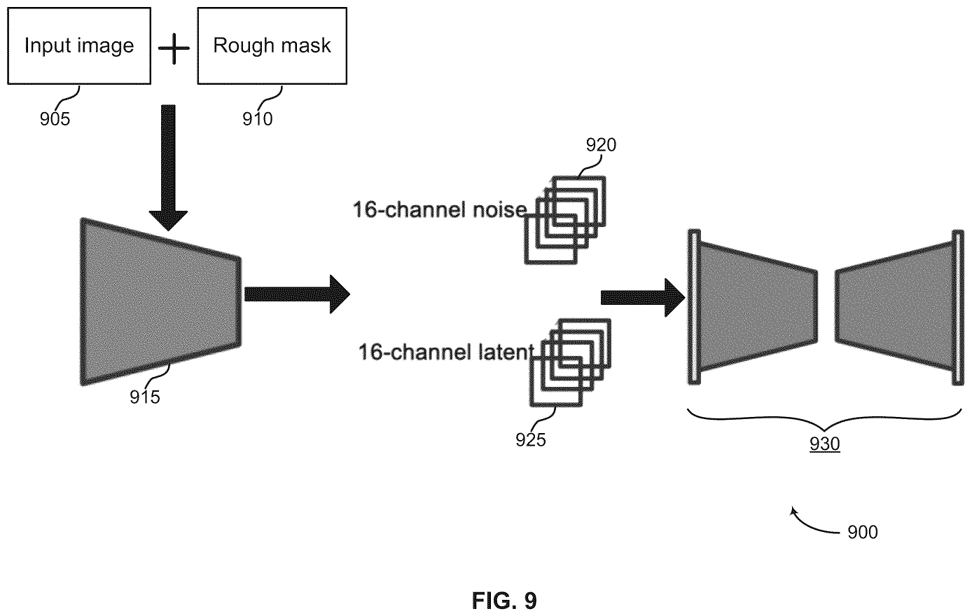

In some examples, the modified diffusion network incorporates a user-stroke as a conditioning input. For example, the conditioning input indicates an approximate shape of the object. In some examples, the modified diffusion network incorporates an image as a conditioning input. For example, the modified diffusion network with the conditioning input is used to extract the object from the generated image. In some examples, the modified diffusion network with the conditioning input extracts an RGBA version of the foreground (e.g., object) from the generated image. As described herein, RGB represents the image and A represents the alpha channel. Further details regarding the conditioning input are provided with reference to at least FIGS. 8-9.

At operation 220, the system generates a composite image with the extracted object and a new background. In some cases, the operations of this step refer to, or may be performed by, an image processing apparatus as described with reference to FIG. 17.

In some cases, by generating the image at operation 210 with the alpha channel that is obtained from a text prompt, the image processing apparatus generates an image (e.g., a layered PNG file) with different values of transparency for each of the foreground region and the background region. Accordingly, the extracted object (i.e., RGBA foreground) depicts an increased color-decontaminated boundary. In some examples, the extracted RGBA foreground is used for composition.

In some examples, the image is incorporated into a different background (e.g., the image is placed on a different canvas) to generate the composite image. For example, as shown in FIG. 2, the image processing apparatus generates a composite image depicting “a hedgehog on a green background” as stated in the text prompt. Further details regarding the operations 210-215 are described with reference to at least FIGS. 7-9 and 12. The composite image is provided to the user via a user interface of the user device.

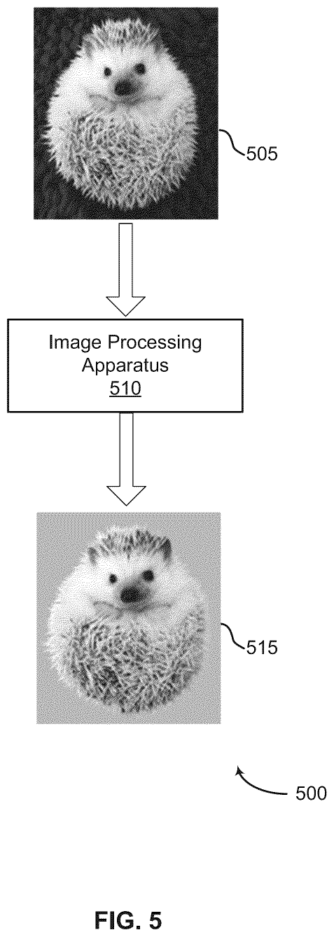

FIG. 3 shows an example of a composite image generation process according to aspects of the present disclosure. In one aspect, composite image generation process 300 includes input image 305, image processing apparatus 310, and output image 315. Composite image generation process 300 is an example of, or includes aspects of, the corresponding element described with reference to FIG. 5.

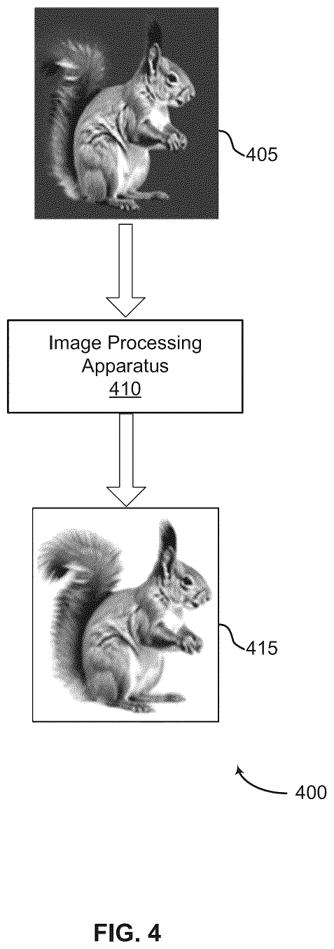

Referring to FIG. 3, input image 305 depicts an image of an object, i.e., a transparent glass containing an opaque liquid. For example, the user wants to replace a background of the transparent glass in input image 305. In some examples, the user provides input image 305 to image processing apparatus 310 via a user interface of the image processing apparatus 310. Input image 305 is an example of, or includes aspects of, the corresponding element described with reference to FIGS. 4, 5, and 9.

The image processing apparatus 310 (such as the image processing apparatus described with reference to at least FIGS. 1-2 and 17) of the present disclosure receives the input image 305 from the user. In some cases, the image processing apparatus 310 comprises a variational autoencoder (such as the variational autoencoder described with reference to FIGS. 6-11 and 18) and a latent diffusion model (such as the diffusion network described with reference to FIGS. 6-11 and 18) that are configured to extract an RGBA version of the object in the image. In some examples, the extracted RGBA object depicts an increased color-decontaminated boundary. In some examples, the extracted RGBA foreground is used for composition to generate output image 315.

In some cases, the image processing apparatus 310 generates output image 315 that depicts a different background for the extracted object (i.e., transparent glass containing the opaque liquid). In some examples, output image 315 accurately depicts the transparent glass and the opaque liquid while preventing occurrence of any pixel associated with a background region of input image 305. Image processing apparatus 310 is an example of, or includes aspects of, the corresponding element described with reference to FIGS. 1, 4, and 5. Output image 315 is an example of, or includes aspects of, the corresponding element described with reference to FIG. 4.

FIG. 4 shows an example of an image segmentation process according to aspects of the present disclosure. In one aspect, image segmentation process 400 includes input image 405, image processing apparatus 410, and segmented image 415.

Referring to FIG. 3, input image 405 depicts an image of an object, i.e., a squirrel on a red background. For example, the user wants to extract the squirrel from the red background for use in compositing. In some examples, the user provides input image 405 to image processing apparatus 410 via a user interface of the image processing apparatus 410. Input image 405 is an example of, or includes aspects of, the corresponding element described with reference to FIGS. 3, 5, and 9.

In some cases, the image processing apparatus 410 comprises a variational autoencoder (such as the variational autoencoder described with reference to FIGS. 6-11 and 18) and a latent diffusion model (such as the diffusion network described with reference to FIGS. 6-11 and 18) that additionally takes an input image and an initial rough mask as input and generates an image based on extracting a foreground region.

According to an exemplary embodiment of the present disclosure, input image 405 depicts a squirrel with a red background. In some examples, an existing segmentation method extracts the squirrel from the red background such that the segmented squirrel includes red pixels associated with the background near a boundary of the foreground and the background regions (particularly in the tail of the squirrel which is hairy). As a result, the segmented squirrel is not useful for a subsequent composition, e.g., the segmented squirrel with red pixels cannot be placed into a background of a different color.

Embodiments of the present disclosure are configured to jointly learn a distribution of an alpha channel and a RGB channel using a dual encoder architecture of the variational autoencoder (such as the dual encoder architecture described with reference to at least FIG. 7). Accordingly, by performing simultaneous encoding of the RGB latent space and the alpha latent space, embodiments of the present disclosure are able to extend the latent space in the RGBA channel which enables extraction of the squirrel to generate segmented image 415. In some cases, segmented image 415 includes clean boundaries (i.e., even in the tail region of the squirrel) and can be easily used for subsequent composition. Image processing apparatus 410 is an example of, or includes aspects of, the corresponding element described with reference to FIGS. 1, 3, and 5.

FIG. 5 shows an example of an image composition process according to aspects of the present disclosure. In one aspect, image composition process 500 includes input image 505, image processing apparatus 510, and output image 515. Composite image generation process 500 is an example of, or includes aspects of, the corresponding element described with reference to FIG. 3.

Referring to FIG. 5, input image 505 depicts an image of an object, i.e., a hedgehog with hairy body surface. For example, the user wants to replace the background of the hedgehog. In some examples, the user provides input image 505 to image processing apparatus 510 via a user interface of the image processing apparatus 510. Input image 505 is an example of, or includes aspects of, the corresponding element described with reference to FIGS. 3, 4, and 9.

The image processing apparatus 510 (such as the image processing apparatus described with reference to at least FIGS. 1-2 and 17) of the present disclosure receives the input image 505 from the user. In some cases, the image processing apparatus 510 comprises a variational autoencoder (such as the variational autoencoder described with reference to FIGS. 6-11 and 18) and a latent diffusion model (such as the diffusion network described with reference to FIGS. 6-11 and 18) that are configured to extract an RGBA version of the hedgehog in the image. In some examples, the extracted RGBA object depicts an increased color-decontaminated boundary for fluffy object (i.e., even with a hairy body surface). In some examples, the extracted RGBA foreground is used for composition to generate output image 515.

In some cases, the image processing apparatus 510 generates output image 515 that depicts a different background for the extracted object (i.e., green background compared to black background in input image 505). In some examples, output image 515 accurately depicts the hedgehog on a green background while preventing occurrence of any pixel associated with the black background region of input image 505 (e.g., based on segmenting the image as in FIG. 4). Image processing apparatus 510 is an example of, or includes aspects of, the corresponding element described with reference to FIGS. 1, 3, and 4. Output image 515 is an example of, or includes aspects of, the corresponding element described with reference to FIG. 3.

FIG. 6 shows an example of a guided diffusion model 600 according to aspects of the present disclosure. In some examples, guided diffusion model 600 describes the operation and architecture of the image generation model 1815 described with reference to FIG. 18. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

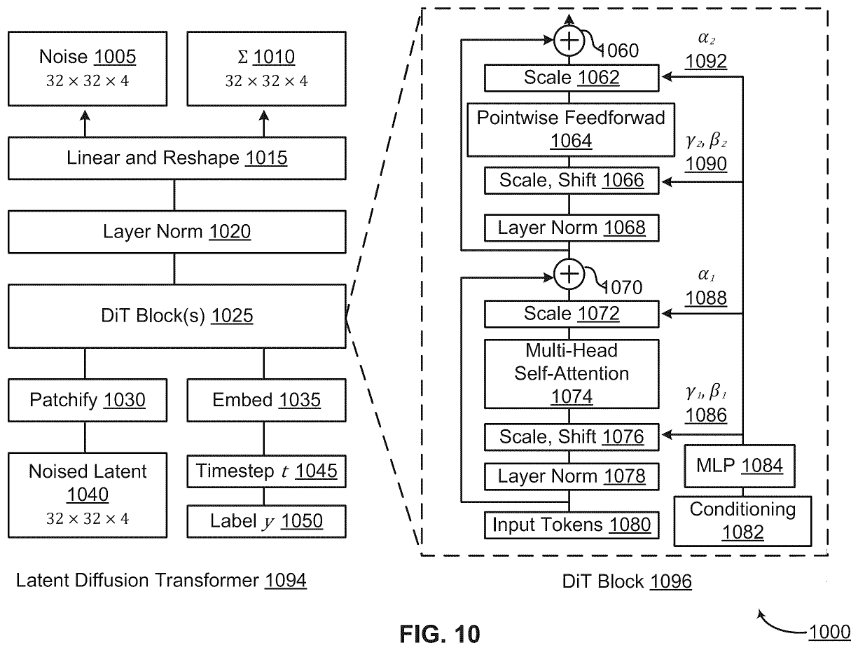

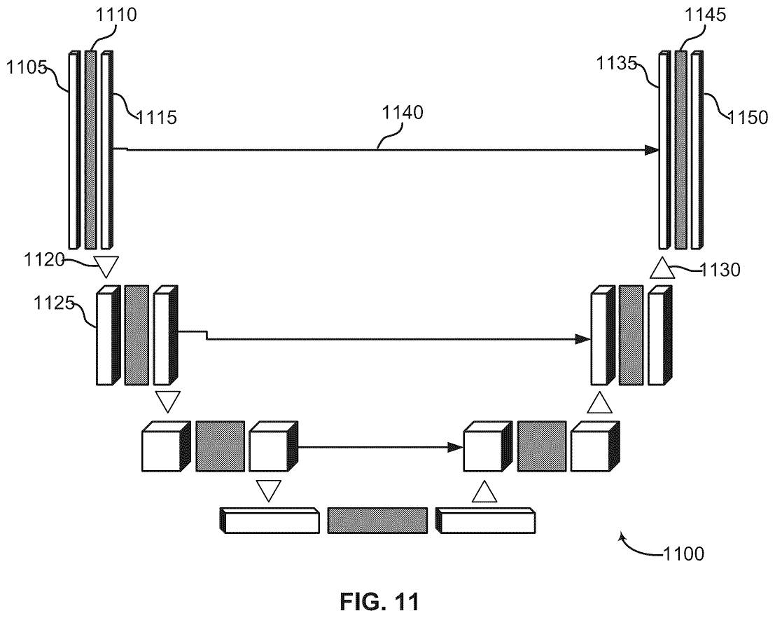

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625. In some aspects, reverse diffusion process 625 can be a diffusion transformer as described with reference to FIG. 10, or a U-Net as described with reference to FIG. 11.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 10, 11, and 14-16.

FIG. 7 shows an example of an image generation framework according to aspects of the present disclosure. In one aspect, image generation model 700 includes image encoder 705, noisy latent color channel 710, noisy latent alpha channel 715, decoder 720, variational autoencoder 725, and diffusion model 730. Image generation model 700 is an example of, or includes aspects of, the corresponding element described with reference to FIGS. 8, 9, and 17.

The present disclosure describes systems and methods for image generation. The image processing apparatus (such as the image processing apparatus described with reference to FIGS. 1-5 and 17) comprises a variational autoencoder 725 and a latent diffusion model 730. In some cases, the image processing apparatus comprises a first encoder E to encode an RGB channel associated with the image. In some cases, the image processing apparatus comprises image encoder E1 705 to encode an alpha channel associated with the image.

Image encoder 705 generates the latent embedding corresponding to the input prompt to obtain a guidance embedding. In some aspects, generating the latent embedding includes encoding the input prompt to obtain the guidance embedding representing the object. Image encoder 705 is an example of, or includes aspects of, the corresponding element described with reference to FIGS. 8, 9, and 18.

As described herein, the alpha channel in an image represents the level of transparency for each pixel. The alpha channel is an additional channel (or layer) that exists alongside the Red, Green, and Blue (RGB) channels in an image. The alpha channel specifies the opacity or transparency of a pixel, thereby providing for operations including, but not limited to, blending, masking, or overlaying images on various backgrounds. For example, the alpha channel values typically range from 0 to 255 (if using 8-bit data), where 0 indicates complete transparency, 255 indicates complete opacity, and values between 0 and 255 indicate partial transparency.

In some cases, the alpha channel is a 4-channel latent as shown in noisy latent alpha channel 715 in FIG. 7. In some cases, the alpha channel is concatenated to a 12-channel RGB latent (such as 12-channels in noisy latent color channel 710) to generate a 16-channel latent space. In some cases, the image generation model comprises a decoder D1 720 to reconstruct the RGBA back to a pixel space. Accordingly, by implementing a single decoder D1 for the reconstruction, embodiments of the present disclosure are able to ensure increased consistency between the image and the alpha channel.

Noisy latent color channel 710 is an example of, or includes aspects of, the corresponding element described with reference to FIG. 8. Noisy latent alpha channel 715 is an example of, or includes aspects of, the corresponding element described with reference to FIG. 8. Decoder 720 is an example of, or includes aspects of, the corresponding element described with reference to FIG. 8.

The image generation model 700 comprises a variational autoencoder 725 that includes a dual-encoder (first encoder E and image encoder E1 715) and a single-decoder (decoder 720). Additionally, the image generation model comprises latent diffusion model 730, wherein the input layer and the output layer of the latent diffusion model 730 is increased to 16 channels to match the dimension of a latent space of the variational autoencoder. Further details regarding an operation of the diffusion model are provided with reference to FIGS. 6 and 10-11.

Variational autoencoder 725 is an example of, or includes aspects of, the corresponding element described with reference to FIGS. 8 and 18. Diffusion model 730 is an example of, or includes aspects of, the corresponding element described with reference to FIGS. 8, 9, and 18.

FIG. 8 shows an example of an image generation framework including stroke information according to aspects of the present disclosure. In one aspect, image generation model 800 includes image encoder 805, noisy latent color channel 810, noisy latent alpha channel 815, decoder 820, variational autoencoder 825, diffusion model 830, and latent stroke control channel 835. Image generation model 800 is an example of, or includes aspects of, the corresponding element described with reference to FIGS. 7, 9, and 17.

According to an embodiment of the present disclosure, the image processing apparatus is configured to perform a controlled image generation based on enabling stroke control. In some cases, the image generation model 800 comprises a variational autoencoder (such as variational autoencoder 825) and a latent diffusion model (such as diffusion model 830) that incorporates user-controlled stroke information (i.e., latent stroke control channel 835). Additionally or alternatively, the variational autoencoder 825 is configured to concatenate the latent stroke control channel 835 with the 16-channel RGBA (e.g., the 16-channel RGBA generated as described with reference to FIG. 7).

Image encoder 805 generates the latent embedding including encoding the input prompt to obtain a guidance embedding representing the object. In some aspects, generating the latent embedding includes encoding the input prompt and a user-provided stroke information to obtain a guidance embedding representing the object. Image encoder 805 is an example of, or includes aspects of, the corresponding element described with reference to FIGS. 7, 9, and 18.

In some cases, as shown with reference to FIG. 8, the latent stroke control channel 835 comprises a single channel binary image. In some cases, the stroke is resized to the spatial size of the latent space. Noisy latent color channel 810 is an example of, or includes aspects of, the corresponding element described with reference to FIG. 7. Noisy latent alpha channel 815 is an example of, or includes aspects of, the corresponding element described with reference to FIG. 7. Decoder 820 is an example of, or includes aspects of, the corresponding element described with reference to FIG. 7.

In some cases, the latent stroke control channel 835 is concatenated with the 16-channel RGBA latent (i.e., generated using decoder 820 using image generation model 700 described with reference to FIG. 7) to generate a 17-channel input for the latent diffusion model 830. For example, the input channel of the latent diffusion model 830 is updated to 17 channels. Variational autoencoder 825 is an example of, or includes aspects of, the corresponding element described with reference to FIGS. 7 and 18. Diffusion model 830 is an example of, or includes aspects of, the corresponding element described with reference to FIGS. 7, 9, and 18.

In some cases, the image generation model 800 is configured to enable user-provided stroke information in RGBA generation resulting in increased control of the user on the generated image. In some cases, the image generation model 800 is configured to generate an alpha based on the user-provided stroke information (i.e., latent stroke control channel 835). For example, the user-provided stroke information indicates an approximate shape of the object. For example, the generated alpha indicates an accurate shape of the object that has an improved alignment with the boundaries of the object.

FIG. 9 shows an example of an image segmentation framework according to aspects of the present disclosure. In one aspect, image generation model 900 includes input image 905, rough mask 910, image encoder 915, noise embedding 920, latent embedding 925, and diffusion model 930. Image generation model 900 is an example of, or includes aspects of, the corresponding element described with reference to FIGS. 7, 8, and 17.

As shown with reference to FIG. 9, the image processing apparatus is configured to generate an image comprising an alpha channel. In some cases, the image generation model 900 comprises an image encoder 915 of a variational autoencoder and a latent diffusion model 930 that additionally takes input image 905 and an initial rough mask 910 as input. In some cases, the image generation model 900 generates an image based on extracting a foreground region of input image 905. In some cases, the initial rough mask 910 is obtained by a segmentation model to indicate an approximate location of the foreground region (such as using processes as described with reference to FIG. 4). Input image 905 is an example of, or includes aspects of, the corresponding element described with reference to FIGS. 3-5.

In some cases, the variational autoencoder is configured to encode the input image 905 and the initial rough mask 910 to generate an additional 16-channel latent (i.e., latent embedding 925), i.e., in addition to the 16-channel RGBA latent (i.e., noise embedding 920). In some cases, the image processing apparatus is configured to concatenate the additional 16-channel latent (latent embedding 925) and the 16-channel RGBA latent (noise embedding 920) to generate a 32-channel latent. Image encoder 915 is an example of, or includes aspects of, the corresponding element described with reference to at least FIGS. 7, 8, and 18.

For example, the latent diffusion model 930 uses the 32-channel latent as input and efficiently generates an image that accurately aligns with each aspect of the input image and the initial rough mask. Diffusion model 930 is an example of, or includes aspects of, the corresponding element described with reference to FIGS. 7, 8, and 18.

Embodiments of the present disclosure are configured to jointly learn a distribution of a 4-channel alpha and 12-channel RGB using a dual encoder architecture of the variational autoencoder. Accordingly, by performing simultaneous encoding of the RGB latent space and the alpha latent space, embodiments of the present disclosure are able to extend the latent space to 16-channel which enables extraction of an object that includes clean boundaries and can be easily incorporated for subsequent composition.

FIG. 10 shows an example of a diffusion transformer (DiT) architecture 1000 according to aspects of the present disclosure. The example shown includes predicted noise 1005, predicted covariance 1010, linear and reshape layers 1015, normalization layer 1020, DiT block(s) 1025, patchify operation 1030, embedding 1035, noised latent 1040, timestep information 1045, label information 1050, and an implementation of one block in the DiT block(s) 1025 by a DiT Block 1096. The DiT Block 1096 includes: second residual connection 1060, second scaling operations 1062, feed-forward network 1064, post-normalization second scaling and shifting 1066, second normalization 1068, first residual connection 1070, first scaling operations 1072, self-attention 1074, post-normalization first scaling and shifting 1076, first normalization 1078, input tokens 1080, conditioning tokens 1082, multi-layer perceptron (MLP) 1084, post-normalization first scaling and shifting parameters 1086, first scaling parameter 1088, post-normalization second scaling and shifting parameters 1090, and second scaling parameter 1092. In some embodiments, the architecture employes an Latent Diffusion Transformer 1094. In some embodiments, DiT Block 1096 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x→x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all αs; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shapes equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 1000, in some cases, employs a Latent Diffusion Transformer 1094. The architecture 1000 processes noised latent 1040, which may be a noised version of an input image encoded in a latent space. Patchify operation 1030 divides the noised latent into a sequence of patches that are processed as tokens. The tokens are vector representations of each patch of the image in latent space and are adjusted through attention processes. Each of the tokens also receives timestep information 1045 and label information 1050 and, accordingly, their embedding 1035, which encodes the current denoising timestep and class labels as conditional information. In some cases, embedding 1035 is referred to as conditional embedding or conditional information embedding. In some cases, a positional embedding which encodes each token's spatial position in the image is applied to the patchified input tokens at the patchify operations 1030. In some examples the positional embedding is ViT frequency-based positional embedding. The input tokens 1080 generated by the patchify operation 1030 and the conditioning tokens 1082 generated by the embedding 1035 are processed through N DiT block(s) 1025, where N may be 12, 24 or 28. Other values of N may be used. In some cases, conditional tokens refer to tokens generated based on embedding 1035 encoding timestep information 1045 and label information 1050.

Each of the DiT block(s) 1025 includes multiple processing stages. DiT Block 1096 illustrates an embodiment of one block in the DiT block(s) 1025. In some embodiments, the DiT Block 1096 is an example of, or includes aspects of, the adaLN-Zero block. In some cases, input tokens 1080 interact with the conditioning tokens 1082 through multiple attention mechanisms. Particularly, after first normalization 1078 applied to the input tokens and MLP 1084 to the conditional tokens, MLP 1084 generates or updates post-normalization first scaling and shifting parameters 1086, denoted as γ₁, β₁, for post-normalization first scaling and shifting 1076 to scale and shift the output of first normalization 1078 accordingly. As the normalized input tokens obtained from first normalization 1078 are scaled and shifted at post-normalization first scaling and shifting 1076 using the conditional information carried as least in γ₁, β₁, this allows the input information and conditional information to interact. Self-attention 1074 allows the scaled and shifted normalized input tokens, namely the output from post-normalization first scaling and shifting 1076, to attend to each other. MLP 1084 also generates or updates first scaling parameter 1088 denoted as α₁ for first scaling operations 1072 to scale the output of self-attention 1074 (e.g., multi-head self-attention), further interacting the input information and conditional information. The input tokens 1080 is then summed with the output of first scaling operations 1072 at first residual connection 1070. In some examples, α₁ has initial values 0, and the DiT Block 1096 is initialized as the identity function.

A similar process is performed in a second half of the DiT Block 1096. MLP 1084 generates or updates post-normalization second scaling and shifting parameters 1090, denoted as γ₂, β₂, for post-normalization second scaling and shifting 1066 to scale and shift the output of second normalization 1068 accordingly. As the output from second normalization 1068 is scaled and shifted using the conditional information carried at least in γ₂, β₂, this allows the input information and conditional information to further interact. Feed-forward network 1064 then processes the scaled and shifted output from post-normalization second scaling and shifting 1066. MLP 1084 also generates or updates second scaling parameter 1092 denoted as α₂ for second scaling operations 1062 to scale the output of feed-forward network 1064, further interacting the input information and conditional information. In some cases, the feed-forward network 1064 is a pointwise feed-forward network. The output from first residual connection 1070 is then summed with the output of second scaling operations 1062 at second residual connection 1060, and the result is the final output of DiT Block 1096. In some examples, α₂ has initial values 0, and the DiT Block 1096 is initialized as the identity function. This process repeats for each DiT block in the sequence.

After processing through all DiT block(s) 1025, the outputs undergo normalization layer 1020 followed by linear and reshape layers 1015. The final output is the predicted noise 1005, which represents the model's prediction of the noise that was added to initially create the noised latent 1040, and the predicted covariance 1010, which represents the model's prediction of the covariance. The predicted noise 1005 is removed from noised latent 1040 at each diffusion timestep, and the predicted covariance may affect how noise is removed or resampled in the reverse or denoising process. At the end of the denoising schedule, the latent sample is decoded to generate the synthetic image in pixel space.

FIG. 11 shows an example of a U-Net 1100 according to aspects of the present disclosure. In some examples, U-Net 1100 is an example of the component that performs the reverse diffusion process 625 of guided diffusion model 600 described with reference to FIG. 6 and includes architectural elements of the image generation model 1815 described with reference to FIG. 18. The U-Net 1100 depicted in FIG. 11 is an example of, or includes aspects of, the architecture used within the reverse diffusion process described with reference to FIG. 6.

In some examples, diffusion models are based on a neural network architecture known as a U-Net. The U-Net 1100 takes input features 1105 having an initial resolution and an initial number of channels and processes the input features 1105 using an initial neural network layer 1110 (e.g., a convolutional network layer) to produce intermediate features 1115. The intermediate features 1115 are then down-sampled using a down-sampling layer 1120 such that down-sampled features 1125 features have a resolution less than the initial resolution and a number of channels greater than the initial number of channels.

This process is repeated multiple times, and then the process is reversed. That is, the down-sampled features 1125 are up-sampled using up-sampling process 1130 to obtain up-sampled features 1135. The up-sampled features 1135 can be combined with intermediate features 1115 having the same resolution and number of channels via a skip connection 1140. These inputs are processed using a final neural network layer 1145 to produce output features 1150. In some cases, the output features 1150 have the same resolution as the initial resolution and the same number of channels as the initial number of channels.

In some cases, U-Net 1100 takes additional input features to produce conditionally generated output. For example, the additional input features could include a vector representation of an input prompt. The additional input features can be combined with the intermediate features 1115 within the neural network at one or more layers. For example, a cross-attention module can be used to combine the additional input features and the intermediate features 1115. U-Net architecture is an example of, or includes aspects of, the corresponding element described with reference to FIGS. 2, 6, 11, and 14-16.

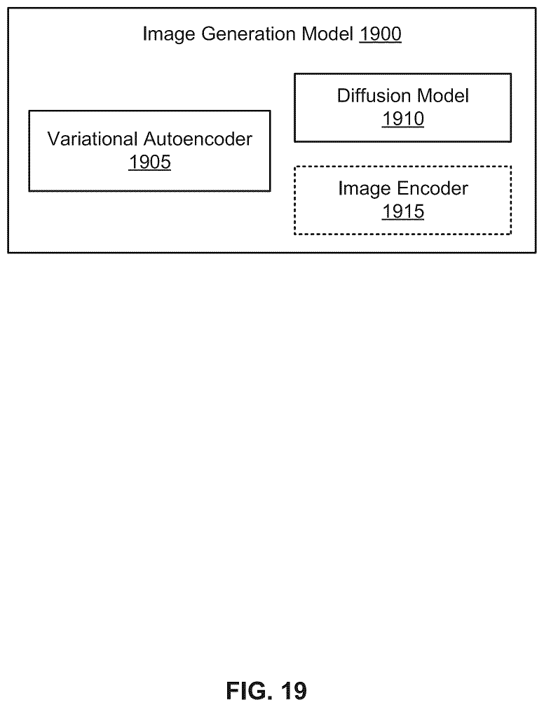

FIG. 12 shows a diffusion process 1200 according to aspects of the present disclosure. In some examples, diffusion process 1200 describes an operation of the image generation model 1815 described with reference to FIG. 18 or image generation model 1900 described with reference to FIG. 19, such as the reverse diffusion process 625 of guided diffusion model 600 described with reference to FIG. 6.

As described above with reference to FIG. 6, using a diffusion model can involve both a forward diffusion process 1205 for adding noise to a media item (or features in a latent space) and a reverse diffusion process 1210 for denoising the media item (or features) to obtain a denoised media item. The forward diffusion process 1205 can be represented as q(xₜ|xₜ₋₁), and the reverse diffusion process 1210 can be represented as p(xₜ₋₁|xₜ). In some cases, the forward diffusion process 1205 is used during training to generate media items with successively greater noise, and a neural network is trained to perform the reverse diffusion process 1210 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1210, the model begins with noisy data x_{T}, such as a noisy media item 1215 and denoises the data to obtain the p(xₜ₋₁|xₜ). At each step t−1, the reverse diffusion process 1210 takes xₜ, such as first intermediate media item 1220, and t as input. Here, t represents a step in the sequence of transitions associated with different noise levels, The reverse diffusion process 1210 outputs xₜ₋₁, such as second intermediate media item 1225 iteratively until x-reverts back to x₀, the original media item 1230. The reverse process can be represented as:

p_{θ}(xₜ₋₁|xₜ):=N(xₜ₋₁;μ_{θ}(xₜ,t),Σ_{θ}(xₜ,t) (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality. Diffusion process is an example of, or includes aspects of, the corresponding element described with reference to FIGS. 2, 6, 10-12, and 15-17.

Accordingly, an apparatus for image processing is described. One or more aspects of the apparatus include a memory component; a processing device coupled to the memory component, the processing device configured to perform operations comprising: obtaining an input prompt indicating an object; generating, using an image generation model, a latent embedding based on the input prompt, wherein the latent embedding includes a latent color channel corresponding to at least a part of the object and a latent alpha channel; and generating, using the image generation model, a synthetic image based on the latent embedding, wherein the synthetic image depicts the object based on the latent color channel and includes an alpha channel based on the latent alpha channel.

In some aspects, the image generation model comprises a variational autoencoder network. In some aspects, the variational autoencoder network is trained using a color channel encoder and an alpha channel encoder. In some aspects, the image generation model comprises a latent diffusion network.

In some aspects, the image generation model is trained to generate the synthetic image with the alpha channel based on a loss function including an alpha channel loss term. Some examples of the apparatus and system further include an image encoder configured to generate an image embedding representing an input image and an input mask.

### Image Generation Process

The present disclosure describes systems and methods for image generation. Embodiments of the present disclosure include an image generation model configured to generate an image together with an alpha channel. In some cases, the alpha channel is obtained from a text prompt. For example, the image generation model generates an image (e.g., a layered PNG file) with different values of transparency for each of the foreground and the background. In some examples, the image is incorporated into a different background (e.g., the image is placed on a different canvas) which eases a designing process.

Embodiments of the present disclosure include an image generation model configured to generate an image depicting a transparent background. In some cases, the image generation model comprises a diffusion model with the RGB channels representing an image and an A channel representing the alpha channel. According to an embodiment, the image generation model comprises a modified diffusion network that learns to directly model RGBA data distribution.

Embodiments of the present disclosure include an image generation model configured to jointly learn a 4-channel RGBA distribution. In some cases, the image generation model extends a latent space of an RGB model from a 12-channel to a 16-channel. For example, the image generation model comprises a dual-encoder single-decoder architecture to perform the extension to the 16-channel.

In some cases, the image generation model incorporates user-stroke information to provide an approximate shape information for enhanced controllability. In some cases, the image generation model generates an RGBA image. Additionally, the image generation model is configured to perform an RGBA extraction from an image. In some cases, the image generation model is configured to generate a color-decontaminated foreground based on formulation in a generative setting. Accordingly, by generating an image with the color-decontaminated foreground, embodiments of the present disclosure provide for ease of post-processing including, but not limited to, image composition, etc.

FIG. 13 shows an example of a method 1300 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system obtains an input prompt indicating an object. In some cases, the operations of this step refer to, or may be performed by, an image processing apparatus as described with reference to FIG. 17. In some examples, the method includes obtaining an input prompt including a depiction of an object on a background.

For example, in some cases, the user interface of the image processing apparatus (such as image processing apparatus 1800 described with reference to FIG. 18) receives an input prompt from a user. In some examples, the input prompt is a text prompt that describes an object that the user wants to depict in the generated asset (e.g., synthetic image). Additionally or alternatively, for example, the input prompt is a text prompt that describes a background associated with the object that the user wants to depict in the generated asset (e.g., synthetic image). In some examples, the image processing apparatus receives the input prompt from a database or any other data source.

At operation 1310, the system generates a latent embedding based on the input prompt, where the latent embedding includes a latent color channel corresponding to at least a part of the object and a latent alpha channel. In some cases, the operations of this step refer to, or may be performed by, an image generation model as described with reference to FIG. 19. In some examples, the method includes generating, using an image generation model, a latent embedding based on the input prompt, wherein the latent embedding represents the object and transparency information corresponding to the background of the object.

Embodiments of the present disclosure include an image processing apparatus that comprises an image generation model (such as the image generation model described with reference to FIGS. 6-11). In some cases, as described with reference to FIG. 7, the image generation model comprises a variational autoencoder (such as variational autoencoder 725) and a latent diffusion model (such as latent diffusion model 730). In some cases, the image processing apparatus comprises an image encoder (such as image encoder 705 described with reference to FIG. 7) to encode an alpha channel in an image. In some cases, the alpha channel is a 4-channel latent. In some cases, the alpha channel is concatenated to a 12-channel RGB latent to generate a 16-channel latent space.

At operation 1315, the system generates a synthetic image based on the latent embedding, where the synthetic image depicts the object based on the latent color channel and includes an alpha channel based on the latent alpha channel. In some cases, the operations of this step refer to, or may be performed by, an image generation model as described with reference to FIG. 18. In some examples, the method includes generating, using the image generation model, a synthetic image based on the latent embedding, wherein the synthetic image depicts the object and includes an alpha channel in place of the background.

In some cases, the image generation model comprises a decoder (such as decoder 720 described with reference to FIG. 7) to reconstruct the RGBA back to a pixel space. Accordingly, by implementing a single decoder for the reconstruction, embodiments of the present disclosure are able to ensure increased consistency between the image and the alpha channel.

The image generation model comprises a variational autoencoder (such as variational autoencoder 725 described with reference to FIG. 7) that includes a dual-encoder (such as encoders E and E1 described with reference to FIG. 7) and a single-decoder (such as decoder D1 described with reference to FIG. 7). Additionally, the image generation model comprises a latent diffusion model (such as latent diffusion model 730 described with reference to FIG. 7), wherein the input layer and the output layer of the latent diffusion model is increased to 16 channels to match the dimension of a latent space of the variational autoencoder.

In some cases, the synthetic image is generated via a diffusion process based on the 16 channels as described with reference to at least FIGS. 6-7 and 10-12. In some cases, the image generation model provides the synthetic image to the user via the user interface (such as the user interface described with reference to at least FIGS. 1-5) of the user device.

Embodiments of the present disclosure are configured to generate images including complex objects (e.g., fluffy objects, transparent background, etc.) based on simultaneous generation of an RGB channel and an alpha channel of the image. Accordingly, by performing the RGB channel and alpha channel generation using a single image generation model, embodiments of the present disclosure are able to directly model the RGBA distribution which ensures consistency and correspondence between the RGB channel and the alpha channel. In some cases, use of the single image generation model results in reduction of additional model overhead while minimizing the likelihood of prediction errors.

Accordingly, a method for image processing is described. One or more aspects of the method include obtaining an input prompt indicating an object; generating, using an image generation model, a latent embedding based on the input prompt, wherein the latent embedding includes a latent color channel corresponding to at least a part of the object and a latent alpha channel; and generating, using the image generation model, a synthetic image based on the latent embedding, wherein the synthetic image depicts the object based on the latent color channel and includes an alpha channel based on the latent alpha channel.

Some examples of the method, apparatus, and non-transitory computer readable medium further include generating the latent embedding comprises: encoding the input prompt to obtain a guidance embedding representing the object. Some examples further include obtaining a noise embedding including a noisy latent color channel corresponding to the latent color channel and a noisy latent alpha channel corresponding to the latent alpha channel. Some examples further include denoising the noise embedding based on the guidance embedding to obtain the latent embedding.

In some aspects, the latent embedding includes a latent stroke control channel. In some aspects, the input prompt comprises an input image depicting the object and an input mask indicating a location of the object.

In some aspects, the synthetic image comprises a segmented image separating the object from a background region of the input image. In some aspects, the image generation model is trained to generate the synthetic image with the alpha channel based on a loss function including an alpha channel loss term. In some aspects, a decoder of the image generation model is trained using a color channel encoder and an alpha channel encoder.

### Training

The present disclosure describes systems and method for image generation. According to an exemplary embodiment, the image processing apparatus is configured to filter RGBA data to generate a training dataset. For example, the image processing apparatus filters 1.26 million RGBA data for generation of the training dataset. In some examples, a manual filtering process is used for generation of the training dataset. In some examples, the image processing apparatus performs an automatic filtering process. For example, the image processing apparatus performs automatic filtering of approximately 5 million RGBA data comprising noisy and low-quality data based on a 4-channel criteria.

FIG. 14 shows an example of a criteria for data filtering according to aspects of the present disclosure. In one aspect, data filtering criteria 1400 includes clip art image 1405 and an image with transparency information 1410.

An embodiment of the present disclosure is configured to perform data filtering based on a set of criteria to curate high quality data for training. In some examples, a CLIP model is used to classify and prevent use of clip art images 1405. In some cases, the image processing apparatus of the present disclosure is configured to filter (e.g., filter out or prevent use of) data with an alpha channel comprising values 0 and/or 255. For example, the image processing apparatus is configured to identify RGBA data depicting hair and glass as shown in images with transparency information 1410. Additionally, for example, the image processing apparatus is configured to identify RGBA data with low-quality alpha comprising unnecessary background pixels. Additionally, for example, the image processing apparatus is configured to identify RGBA data with incorrect alpha values, such as a region of glass that is not transparent.

In some cases, the image processing apparatus comprises a training component configured to perform a training of the image generation model. In some cases, the training component trains a variational autoencoder network of the image generation model with a reconstruction loss for the RGB channel and the alpha channel. Additionally, in some cases, the training component trains the variational autoencoder network of the image generation model with an alpha channel loss.

According to an embodiment of the present disclosure, the alpha channel loss is based on computing a product (e.g., multiplication) of the RGB channel and the alpha channel. In some cases, the alpha channel loss is used for the foreground region of the image (i.e., background pixels are not considered due to transparency of the background pixels).

lossₘᵤₗ=∥RGB*A−RGB_gt*A_gt∥ (3)

where RGBA is an output of the variational autoencoder of the image generation model, RGB_gt and A_gt indicate the ground-truth values of RGB and alpha channels, respectively. In some examples, the image generation model is trained on a resolution of 256 pixels, 512 pixels, and 1024 pixels.

The image generation model comprises a latent diffusion model (such as diffusion model described with reference to FIGS. 6-12 and 19). In some cases, the latent diffusion model includes two streams of input, i.e., 16-channel noise map selected randomly from a uniform distribution, where 12-channel is associated with the color information (RGB) and 4-channel is associated with the transparency information (alpha). Additionally, in some cases, the latent diffusion model includes a text prompt input, wherein the text prompt input comprises a language embedding and is combined with the image generation model (such as image generation model described with reference to FIGS. 6-12) via a cross-attention operation.

In some examples, the training component uses a learning objective for the RGBA dataset. In some cases, the learning objective is configured to optimize for negative log likelihood, wherein the ground-truth distribution is a 4-channel combination of the RGB data and the alpha data. In some cases, the training component implements the learning objective based on weights that are randomly initialized from a Gaussian distribution. In some cases, the weights are finetuned till convergence.

An exemplary embodiment is configured to perform a training process of the image generation model comprising user-stroke information. In case of the image generation model comprising user-stroke information, an alpha channel of data is an approximation of the user-stroke information. In some cases, the training objective of the image generation model comprising user-stroke information is consistent with the training objective of the image generation model without user-stroke information.

An embodiment of the present disclosure includes an image generation model (such as image generation model 900 described with reference to FIG. 9) configured to generate a synthetic image based on an input image and an initial rough mask. In some cases, the training component uses a set of synthetic data for training of the additional image generation model. For example, the image generation model generates approximately 160 k RGBA image data and subsequently selects 10 images as background for each of the generated RGBA image data. In some examples, the image generation model generates 1.6 million <Image, RGBA> pairs. In some examples, the image generation model extracts a mask as an additional input.

Accordingly, by separately extracting a mask, embodiments of the present disclosure are able to ensure that the image generation model performs an RGBA extraction while focusing on generating boundaries that prevent unnecessary background pixels. Additionally, the training objective of the additional image generation model is consistent with the training objective of the image generation model. In some cases, the training objective of the additional image generation model uses the generated RGBA image data as ground truth.

FIG. 15 shows an example of a method of training a machine learning model according to aspects of the present disclosure. FIG. 15 is a flow diagram depicting an algorithm as a step-by-step procedure 1500 in an example implementation of operations performable for training a machine-learning model. In some embodiments, the procedure 1500 describes an operation of the training component 1825 described for configuring the image generation model 1815 as described with reference to FIG. 18. The procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm is selected (1512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1514) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore, once trained is configured to perform that task based on subsequent data received as an input and processed by the machine-learning model. The machine learning model is an example of, or includes aspects of, the image generation model described with reference to FIGS. 2, 5-8, 11-14, 16, and 18-19.

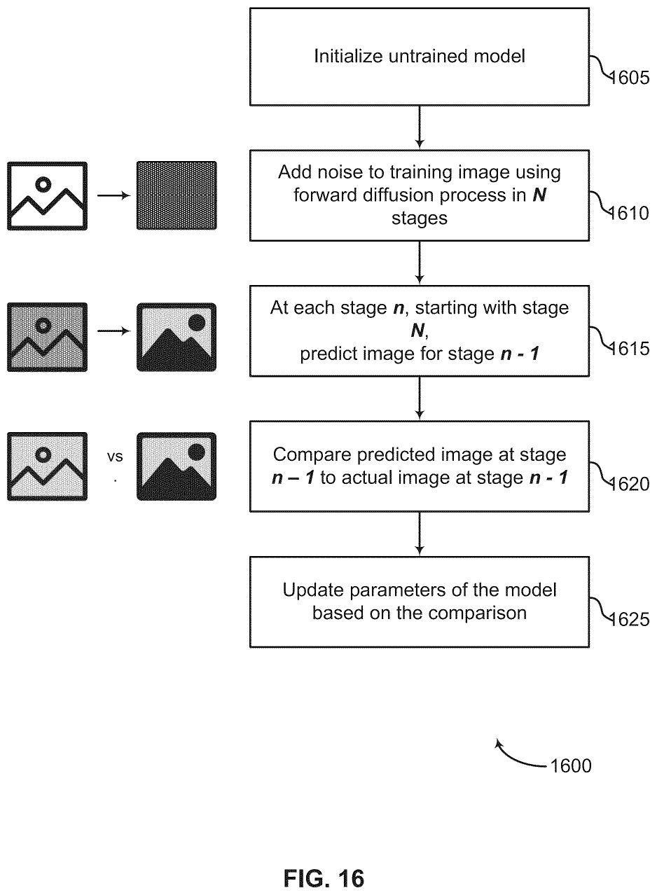

FIG. 16 shows an example of a method of training a diffusion model 1600 according to aspects of the present disclosure. In some embodiments, the method 1600 describes an operation of the training component 1825 described for configuring the image generation model 1815 as described with reference to FIG. 18. The method 1600 represents an example for training a reverse diffusion process as described above with reference to FIGS. 6 and 10-12. In some examples, these operations are performed by a system including a processor executing a set of codes to control functional elements of an apparatus, such as the guided diffusion model described in FIG. 6.

Additionally or alternatively, certain processes of method 1600 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 16, according to some aspects, a training component (such as the training component 1825 described with reference to FIG. 18) trains a diffusion model (such as the image generation model described with reference to FIGS. 6-12 and 19) to generate an output.

At operation 1605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1610, the system adds noise to a training image (or an additional training image) using a forward diffusion process (such as the forward diffusion process described with reference to FIG. 6) in N stages. In some cases, the operations of this step refer to, or may be performed by, a training component as described with reference to FIG. 18.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1625, the system updates parameters of the model based on the comparison. For example, parameters of a U-Net may be updated using gradient descent. Time-dependent parameters of the Gaussian transitions can also be learned.

Accordingly, a method for image processing is described. One or more aspects of the method include obtaining an input prompt indicating an object; generating, using an image generation model, a latent embedding based on the input prompt, wherein the latent embedding represents the object and transparency information; and generating, using the image generation model, a synthetic image based on the latent embedding, wherein the synthetic image depicts the object and includes an alpha channel based on the transparency information.

Some examples of the method, apparatus, and non-transitory computer readable medium further include generating the latent embedding comprises encoding the input prompt to obtain a guidance embedding representing the object; obtaining a noise embedding; and denoising the noise embedding based on the guidance embedding to obtain the latent embedding. In some aspects, the latent embedding includes a latent stroke control channel.

In some aspects, the input prompt comprises an input image depicting the object and an input mask indicating a location of the object. In some aspects, the synthetic image comprises a segmented image separating the object from a background region of the input image.

In some aspects, the image generation model is trained to generate the synthetic image with the alpha channel based on a loss function including an alpha channel loss term. In some aspects, a decoder of the image generation model is trained using a color channel encoder and an alpha channel encoder.

### Computing Device

FIG. 17 shows an example of a computing device according to aspects of the present disclosure. The computing device 1700 may be an example of the image processing apparatus 1800 described with reference to FIG. 18. In one aspect, computing device 1700 includes processor(s) 1705, memory subsystem 1710, communication interface 1715, I/O interface 1720, user interface component(s) 1725, and channel 1730.

In some embodiments, computing device 1700 is an example of, or includes aspects of, the image generation model of FIGS. 18-19. In some embodiments, computing device 1700 includes one or more processors 1705 that can execute instructions stored in memory subsystem 1710 to perform image generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

FIG. 18 shows an example of an image processing apparatus 1800 according to aspects of the present disclosure. Image processing apparatus 1800 is an example of, or includes aspects of, the corresponding element described with reference to FIGS. 1 and 3-5.

According to some aspects, image processing apparatus 1800 obtains an input prompt indicating an object. In some examples, image processing apparatus 1800 obtains a noise embedding including a noisy latent color channel corresponding to the latent color channel and a noisy latent alpha channel corresponding to the latent alpha channel. In some aspects, the input prompt includes an input image depicting the object and an input mask indicating a location of the object. In some aspects, the synthetic image includes a segmented image separating the object from a background region of the input image.

According to some aspects, image processing apparatus 1800 obtains an input prompt indicating an object. In some aspects, the input prompt includes an input image depicting the object and an input mask indicating a location of the object.

In one aspect, image processing apparatus 1800 includes processor unit 1805, memory unit 1810, I/O module 1820, and training component 1825. Training component 1825 updates parameters of the image generation model 1815 stored in memory unit 1810. In some examples, the training component 1825 is located outside the image processing apparatus 1800.

According to some aspects, processor unit 1805 comprises a processing device coupled to the memory component. Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, image processing apparatus 1800 uses one or more processors of processor unit 1805 to execute instructions stored in memory unit 1810 to perform functions described herein. For example, the image processing apparatus 1800 may obtain an input prompt indicating an object; generate, using an image generation model, a latent embedding based on the input prompt, wherein the latent embedding includes a latent color channel corresponding to at least a part of the object and a latent alpha channel; generate, using the image generation model, a synthetic image based on the latent embedding, wherein the synthetic image depicts the object based on the latent color channel and includes an alpha channel based on the latent alpha channel.

In one aspect, memory unit 1810 includes image generation model 1815 trained to obtain an input prompt indicating an object; generate, using an image generation model, a latent embedding based on the input prompt, wherein the latent embedding includes a latent color channel corresponding to at least a part of the object and a latent alpha channel; generate, using the image generation model, a synthetic image based on the latent embedding, wherein the synthetic image depicts the object based on the latent color channel and includes an alpha channel based on the latent alpha channel.

For example, after training, the image generation model 1815 may perform inferencing operations as described with reference to FIGS. 1-5 to obtain an input prompt indicating an object; generate, using an image generation model, a latent embedding based on the input prompt, wherein the latent embedding includes a latent color channel corresponding to at least a part of the object and a latent alpha channel; generate, using the image generation model, a synthetic image based on the latent embedding, wherein the synthetic image depicts the object based on the latent color channel and includes an alpha channel based on the latent alpha channel.

Image generation model 1815 is an example of, or includes aspects of, the corresponding element described with reference to FIGS. 3-5. In some embodiments, the image generation model 1815 is an Artificial neural network (ANN) comprising a plurality of networks including the guided diffusion model described with reference to FIG. 6, the diffusion transformer architecture described with reference to FIG. 10, and the U-Net described with reference to FIG. 11. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 1815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1825 may train the image generation model 1815. For example, parameters of the image generation model 1815 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 15-16). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1815 can be used to make predictions on new, unseen data (i.e., during inference).

According to some aspects, training component 1825 trains the image generation model to generate the synthetic image with the alpha channel based on a loss function including an alpha channel loss term. According to some aspects, training component 1825 trains a decoder of the image generation model using a color channel encoder and an alpha channel encoder. According to some aspects, training component 1825 trains the variational autoencoder network using a color channel encoder and an alpha channel encoder.

According to some aspects, training component 1825 computes a loss function based on the filtered dataset (such as the filtered data obtained based on the data filtering criteria described with reference to FIG. 14). In some examples, training component 1825 updates parameters of the image generation model based on the loss function.

I/O module 1820 receives inputs from and transmits outputs of the image processing apparatus 1800 to other devices or users. For example, I/O module 1820 receives inputs for the image generation model 1815 and transmits outputs of the image generation model 1815. According to some aspects, I/O module 1820 is an example of the I/O interface 1720 described with reference to FIG. 17.

FIG. 19 shows an example of an image generation model 1900 according to aspects of the present disclosure.

According to some aspects, image generation model 1900 generates a synthetic image based on the latent embedding, where the synthetic image depicts the object based on the latent color channel and includes an alpha channel based on the latent alpha channel. In some examples, image generation model 1900 denoises the noise embedding based on the guidance embedding to obtain the latent embedding. In some aspects, the latent embedding includes a latent stroke control channel.

According to some aspects, image generation model 1900 generates a synthetic image based on the latent embedding, where the synthetic image depicts the object and includes an alpha channel based on the transparency information. According to some aspects, image generation model 1900 obtains a noise embedding.

In some examples, image generation model 1900 denoises the noise embedding based on the guidance embedding to obtain the latent embedding. In some aspects, the latent embedding includes a latent stroke control channel. In some aspects, the synthetic image includes a segmented image separating the object from a background region of the input image.

In some examples, image generation model 1900 generates a synthetic image based on the latent embedding, wherein the synthetic image depicts the object based on the latent color channel and includes an alpha channel based on the latent alpha channel.

In some aspects, the image generation model 1900 includes a variational autoencoder network 1905. In some aspects, the variational autoencoder network 1905 is trained using a color channel encoder and an alpha channel encoder. In some aspects, the image generation model 1900 includes a latent diffusion network (such as diffusion model 1910 and diffusion models described with reference to at least FIGS. 6-12).

In one aspect, image generation model 1900 includes variational autoencoder network 1905, diffusion model 1910, and image encoder 1915.

Variational Autoencoder (VAE) 1905 is a type of generative model designed to learn a compact, probabilistic representation of data. VAE operates by encoding input data into a latent space, where each point represents a probability distribution rather than a deterministic feature vector. The VAE comprises two primary components: an encoder and a decoder. The encoder maps the input data to a latent distribution, typically modeled as a multivariate Gaussian characterized by mean and variance parameters. Subsequently, a latent sample is drawn from the distribution using a reparameterization trick to enable backpropagation. The decoder reconstructs the original data from this sampled latent representation.

The training objective of the VAE minimizes a combination of reconstruction error and a Kullback-Leibler (KL) divergence term to ensure the latent space distribution approximates a prior, such as a standard normal distribution. The probabilistic modeling enables the generation of new, plausible samples by sampling from the latent space. Variational autoencoder 1905 is an example of, or includes aspects of, the corresponding element described with reference to FIGS. 7-9.

Latent Diffusion Model (LDM) is a generative framework that combines latent space representation with diffusion-based noise modeling to synthesize high-quality data. LDMs first compress input data, such as images, into a lower-dimensional latent space using a pretrained encoder, such as one derived from a VAE or another compression method. The diffusion process operates in the latent space, progressively adding Gaussian noise to the latent representation with over a series of steps. The reverse diffusion process, guided by a neural network, reconstructs the denoised latent representation step by step. Finally, a decoder maps the reconstructed latent space back to the original data domain. The LDM framework significantly reduces computational overhead compared to performing diffusion directly in the high-dimensional data space, while preserving fidelity and detail. LDMs are particularly well-suited for tasks such as image synthesis, super-resolution, and inpainting, leveraging the efficiency and flexibility of latent space representations. Diffusion model 1910 is an example of, or includes aspects of, the corresponding element described with reference to FIGS. 6-12.

An image processing apparatus (such as the image processing apparatus 1800 described with reference to FIG. 18) uses an image encoder 1915 to generate a latent embedding based on the input prompt, where the latent embedding includes a latent color channel corresponding to at least a part of the object and a latent alpha channel. According to some aspects, image encoder 1915 generates a latent embedding based on the input prompt, where the latent embedding represents the object and transparency information.

According to some aspects, image encoder 1915 generates a latent embedding based on the input prompt, wherein the latent embedding includes a latent color channel corresponding to at least a part of the object and a latent alpha channel. According to some aspects, image encoder 1915 generates the latent embedding including encoding the input prompt to obtain a guidance embedding representing the object. In some aspects, generating the latent embedding includes encoding the input prompt to obtain a guidance embedding representing the object. According to some aspects, image encoder 1915 is configured to generate an image embedding representing an input image and an input mask. In some examples, the image encoder 1915 is located outside the variational autoencoder 1905.

An image encoder refers to a machine learning model that is trained to generate embeddings for an input image in an embedding space. The image processing apparatus obtains an image based on the text embedding. Image encoder 1915 is an example of, or includes aspects of, the corresponding element described with reference to FIGS. 7-9.

An “embedding” refers to a representation of an object (e.g., the text prompt) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined.

An “image embedding” refers to an embedding of the image, e.g., a representation of the image in an embedding space. An “embedding space” (or a “vector space”) refers to a set having embeddings (or vectors) as elements and is characterized by a dimension specifying a number of independent directions in the embedding space.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt indicating an object;
generating, using an image generation model, a latent embedding based on the input prompt, wherein the latent embedding includes a latent alpha channel and a latent color channel corresponding to at least a part of the object; and
generating, using the image generation model, a synthetic image based on the latent embedding, wherein the synthetic image depicts the object based on the latent color channel and includes an alpha channel based on the latent alpha channel.

2. The method of claim 1, wherein generating the latent embedding comprises:
encoding the input prompt to obtain a guidance embedding representing the object;
obtaining a noise embedding including a noisy latent color channel corresponding to the latent color channel and a noisy latent alpha channel corresponding to the latent alpha channel; and
denoising the noise embedding based on the guidance embedding to obtain the latent embedding.

3. The method of claim 1, wherein:
the latent embedding includes a latent stroke control channel.

4. The method of claim 1, wherein:
the input prompt comprises an input image depicting the object and an input mask indicating a location of the object.

5. The method of claim 4, wherein:
the synthetic image comprises a segmented image separating the object from a background region of the input image.

6. The method of claim 1, wherein:
the image generation model is trained to generate the synthetic image with the alpha channel based on a loss function including an alpha channel loss term.

7. The method of claim 1, wherein:
a decoder of the image generation model is trained using a color channel encoder and an alpha channel encoder.

8. A non-transitory computer readable medium storing code for image processing, the code comprising instructions that, when executed by at least one processor, cause the at least one processor to perform operations comprising:
obtaining an input prompt including a depiction of an object on a background;
generating, using an image generation model, a latent embedding based on the input prompt, wherein the latent embedding represents the object and transparency information corresponding to the background of the object; and
generating, using the image generation model, a synthetic image based on the latent embedding, wherein the synthetic image depicts the object and includes an alpha channel in place of the background.

9. The non-transitory computer readable medium of claim 8, wherein generating the latent embedding comprises:
encoding the input image to obtain a guidance embedding representing the object;
obtaining a noise embedding; and
denoising the noise embedding based on the guidance embedding to obtain the latent embedding.

10. The non-transitory computer readable medium of claim 8, wherein:
the latent embedding includes a latent stroke control channel.

11. The non-transitory computer readable medium of claim 8, wherein:
the input prompt includes an input mask indicating a location of the object.

12. The non-transitory computer readable medium of claim 11, wherein:
the synthetic image comprises a segmented image separating the object from a background region of the input image.

13. The non-transitory computer readable medium of claim 8, wherein:
the image generation model is trained to generate the synthetic image with the alpha channel based on a loss function including an alpha channel loss term.

14. The non-transitory computer readable medium of claim 8, wherein:
a decoder of the image generation model is trained using a color channel encoder and an alpha channel encoder.

15. A system comprising:
a memory component; and
a processing device coupled to the memory component, the processing device configured to perform operations comprising:
obtaining an input prompt indicating an object;
generating, using an image generation model, a latent embedding based on the input prompt, wherein the latent embedding includes a latent color channel corresponding to at least a part of the object and a latent alpha channel; and
generating, using the image generation model, a synthetic image based on the latent embedding, wherein the synthetic image depicts the object based on the latent color channel and includes an alpha channel based on the latent alpha channel.

16. The system of claim 15, wherein:
the image generation model comprises a variational autoencoder network.

17. The system of claim 16, wherein:
the variational autoencoder network is trained using a color channel encoder and an alpha channel encoder.

18. The system of claim 15, wherein:
the image generation model comprises a latent diffusion network.

19. The system of claim 15, wherein:
the image generation model is trained to generate the synthetic image with the alpha channel based on a loss function including an alpha channel loss term.

20. The system of claim 15, further comprising:
an image encoder configured to generate an image embedding representing an input image and an input mask.
